(19) United States
(12) Patent Application Publication
(10) Pub. No.: US 2022/0258581 A1
(43) Pub. Date: Aug. 18, 2022

(54) MOTOR VEHICLE ROOF HINGE AND METHOD FOR ATTACHING HINGE ON VEHICLE ROOF WITH REMOVABLE ROOF PANELS

(71) Applicant: Robert M. Butler, Rutland, VT (US)

(72) Inventor: Robert M. Butler, Rutland, VT (US)

(21) Appl. No.: 17/669,903

(22) Filed: Feb. 11, 2022

Related U.S. Application Data
(60) Provisional application No. 63/207,175, filed on Feb. 12, 2021.

(51) Int. Cl. B60J 7/14

(52) U.S. Cl. CPC B60J 7/145

(57) ABSTRACT

For a vehicle with at least one removable hardtop roof panel and a fixed hardtop rear rooftop, a hinge is provided that attaches to the removable panel(s) and the rear rooftop. In the case of the Jeep® Freedom Top®, both removable panels are attached to the rear fixed portion of the roof using the hinge, enabling the removable panels to be flipped over the rear of the roof.

### CROSS-REFERENCE TO RELATED APPLICATIONS

This application claims priority to U.S. Provisional Application No. 63/207,175, filed Feb. 12, 2021, which is incorporated by reference herein in its entirety.

### BACKGROUND

Various forms of convertible tops have been offered by automobile manufacturers since the early 1920s, after enclosed cabins were added (starting in 1905) to the original open vehicles. While most convertibles that have been produced use fabric to minimize the storage space required, there have been several manufacturers who have produced automobiles with a retractable hardtop, stored in the rear of the vehicle, starting with the Peugeot 601 Eclipse in 1934 and continuing with models available from Chevrolet, Ferrari, Mazda and McLaren through at least 2021. Partial removal of a hardtop roof was the subject of U.S. Pat. No. 2,556,062 which introduced the “T-top” with two removable panels used in the Chevrolet Corvette (1968-1982) and Camaro (1978-2002) as well as over a dozen other models from several manufacturers. Vehicles with a single removable panel constituting 70% or more of the hardtop roof and known as a Targa® on Porsches and illustrated in FIG. 1 of U.S. Pat. No. 3,526,427, have been available from even more manufacturers starting in 1961 with the Triumph TR4 and continuing with at least one model from various manufacturers through at least 2021.

While the original Willys MB or “Jeep” had a fabric roof, since at least the 2007 Jeep® Wrangler model JK, a Freedom Top® three-piece hardtop has been available from the vehicle manufacturer with removable panels over the driver seat and front passenger seat. Unlike the T-top, there is no longitudinal strut and unlike the Targa®, there are two front rigid roof panels that are removable and constitute much less than 50% of the hardtop roof. When the removable front rigid roof panels are not locked in place to provide a continuous hardtop roof, drivers need to stow the panels. While various forms of bags, etc. for storage inside the vehicle are available, these products themselves must be stowed somewhere when all panels cover the occupant(s) and are cumbersome and time-consuming to use.

### SUMMARY

An aspect of at least one of the embodiments described herein is to provide a hinge that can be attached to at least one removable front rigid roof panel and a fixed rear hardtop roof. In the case of the Jeep® Freedom Top® and Ford BRONCO®, both removable front panels are attached to a rear rigid roof panel that is permanently part of the hardtop roof using the hinge, enabling the removable panels to be flipped over and rest on the rear rigid roof panel.

Another aspect of at least one of the embodiments is to provide a one-piece molded design with a hinge having at least one rotatable connection, each forming a continuous hinge, like that used on a piano.

A further aspect of at least one of the embodiments is to use a single hinge to attach at least two removable panels to the fixed portion of a vehicle hardtop roof, thereby reducing alignment issues.

Yet another aspect of at least one of the embodiments is to attach the hinge to all parts of the hardtop roof using adhesive, thus providing tool free installation and avoiding the need to drill holes in the roof.

A further aspect of at least one of the embodiments is to provide a protruding lower front lip on a single rear leaf of the hinge for aligning the hinge during installation.

Yet another aspect of at least one of the embodiments is to form the protruding lower front lip as a series of locating tabs for aligning the single rear leaf of the hinge with a leading edge of the rigid rear panel.

### BRIEF DESCRIPTION OF DRAWINGS

FIG. 1 is a perspective view of the top, left and rear of a hinge according to a first embodiment.

FIG. 2 is a top view of the hinge according to the first embodiment.

FIG. 3 is a bottom view of the hinge according to the first embodiment, prior to installation.

FIG. 4 is a side view of the hinge according to the first embodiment.

FIG. 5 is a front view of the hinge according to the first embodiment.

FIG. 6 is a side view of the hinge according to the first embodiment with the front leaves perpendicular to the rear leaf.

FIG. 7 is a perspective view of the bottom of a folded hinge according to a first embodiment, ready for installation.

FIG. 8 is a top view of the hinge according to the first embodiment during installation on the roof of a Jeep® Model JK.

FIG. 9 is a top view of a hinge according to a second embodiment that fits a Jeep® Model JL.

### DETAILED DESCRIPTION OF EMBODIMENTS

Reference will now be made in detail to embodiments, examples of which are illustrated in the accompanying drawings. In this regard, the embodiments may have different forms and should not be construed as being limited to the descriptions set forth herein. To further clearly describe features of the embodiments, descriptions of other features that are well known to one of ordinary skill in the art are omitted here.

The articles “a”, “an” and “the” are intended to include both singular and plural forms of the following nouns. Phrases using the term “and/or” include a plurality of combinations of relevant items or any one item among a plurality of relevant items. The term “at least [number]” preceding a list of items denotes any combination of the items in the list that satisfies the expression. In the case of “at least one” the expression includes any one item among a plurality of the listed item(s), as well as multiple items. Expressions such as “at least one of,” when preceding a list of elements, modify the entire list of elements and do not modify the individual elements of the list.

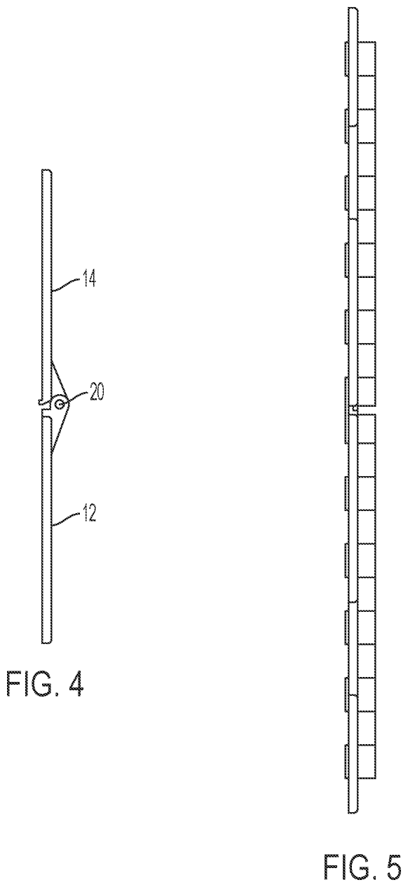

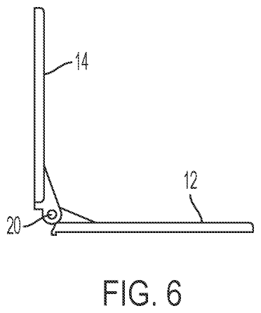

While the Freedom Roof® panels on the Jeep® Model JK provide the option to remove and store at any time, unlike prior one-piece Jeep® hardtops, they are not easy to remove and are cumbersome to store. Illustrated in the drawings is a hinge 10 with a single rear leaf 12 and at least one front leaf, specifically two front leaves: driver-seat leaf 14 and front passenger-seat leaf 16. In the illustrated embodiment, each of the front leaves 14, 16 are connected to the rear leaf 12 using a continuous hinge formed by a pin 20 (FIGS. 4 and 6); however other types of hinges can be used.

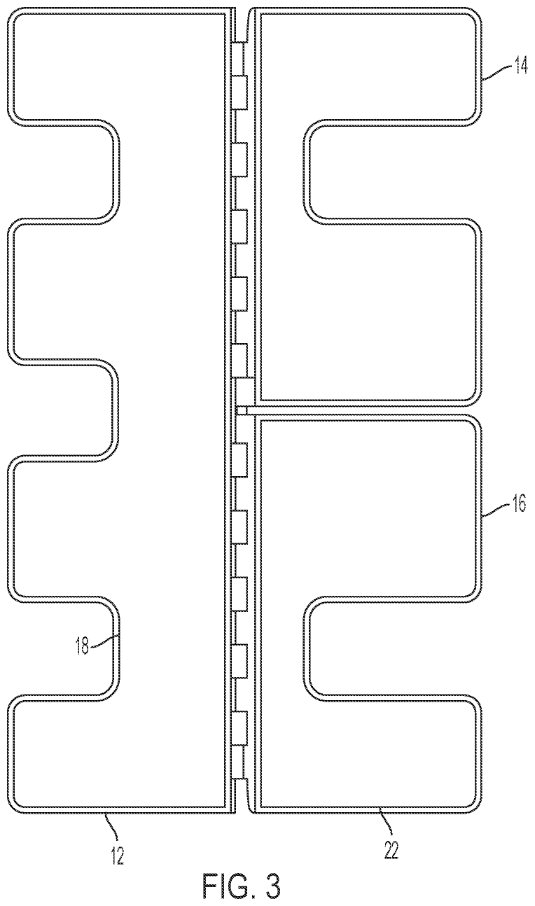

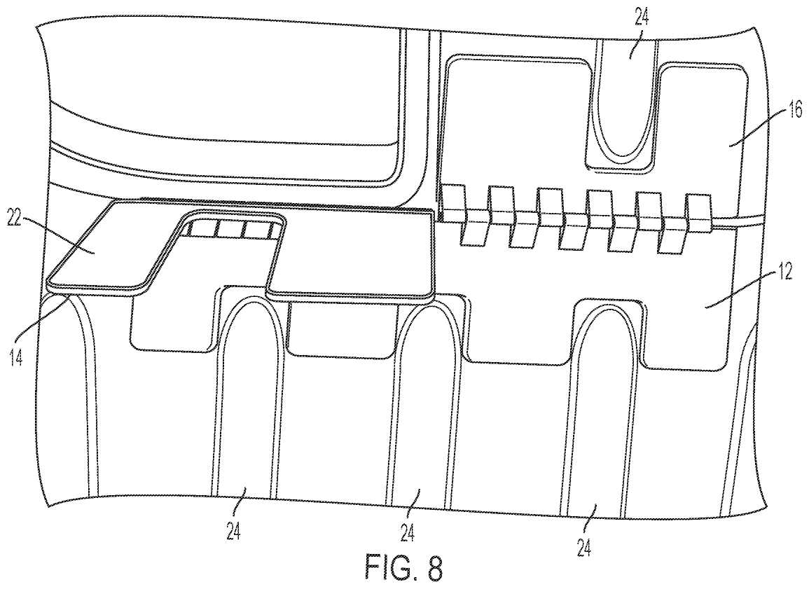

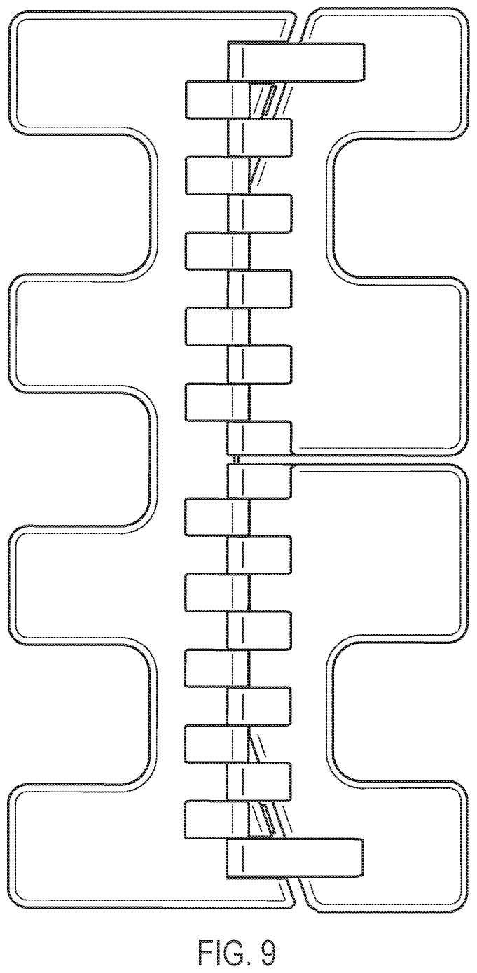

The hinge 10 can be made from any commercially available material using any manufacturing process, such as molding, machining, etc. In an embodiment, the hinge is molded using a high-strength automotive industry standard UV resistant plastic. The hinge can be attached to the removable roof panels and rear roof by adhesive or mechanical fasteners. In the embodiment illustrated in FIGS. 3 and 8, a high strength adhesive tape or any other commercially available adhesive tape is covered by a film 22 prior to installation.

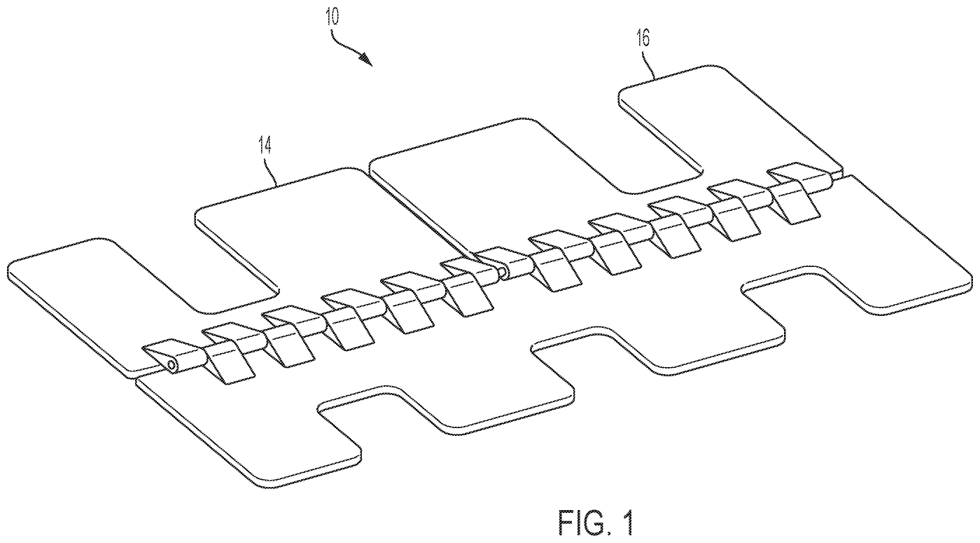

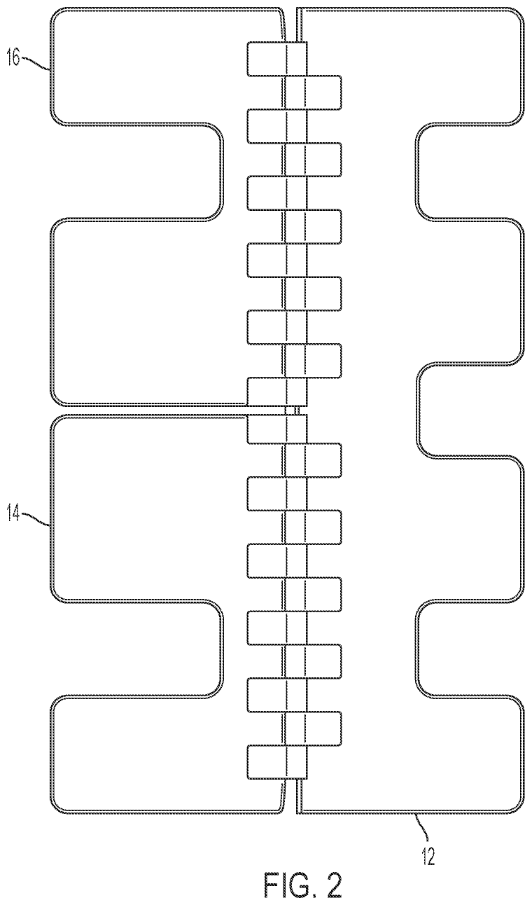

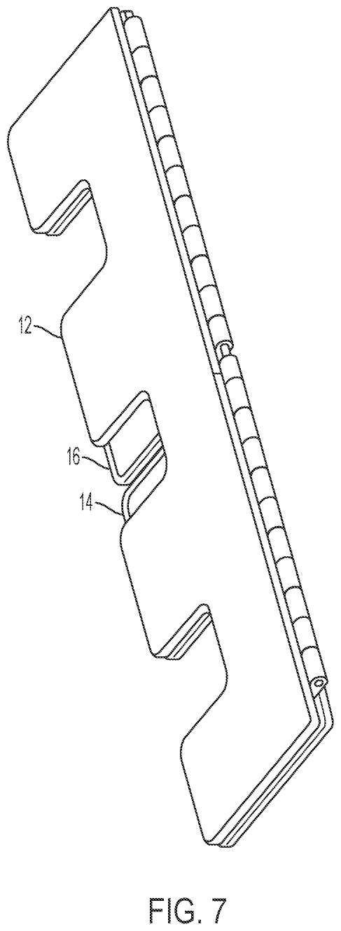

The embodiment of the hinge illustrated in FIGS. 1-8 can be installed by first removing the driver-seat panel, leaving front passenger-seat panel 23 in place as illustrated in FIG. 8. When adhesive is used, as in the illustrated embodiments, the roof panels are thoroughly cleaned in a conventional manner and may be further cleaned using alcohol infused towelettes. After cleaning, the surfaces of the rear and front panels to which adhesive will be applied may be prepared using an adhesion promoter such as 3M® part number 06396. Next, the rear leaf 12 and front passenger-seat leaf 16 are transversely aligned with the ribs 24 on the rear rigid roof panel 26 and front passenger-seat panel 23. Then, front passenger-seat leaf 16 is more precisely aligned with the edge of the front passenger-seat panel 23 and longitudinally aligned by pressing locating tabs 28 (see FIGS. 4-6) formed from a protruding lower front lip on the front edge of the rear leaf 12 into the gap between the rear rigid roof panel 26 and the front passenger-seat panel 23 and against the leading edge of the rear rigid roof panel 26.

While keeping locating tabs 28 pressed against the leading edge of the rear rigid roof panel 26 and front passenger-seat leaf 16 aligned with the edge of the front passenger-seat panel 23, the covering film 22 is removed from the adhesive tape on the rear leaf 12, the rear leaf 12 is rotated onto the rear rigid roof pane126 and pressed into place on a front portion the rear rigid roof panel 26. With the rear leaf 12 adhered to the rear rigid roof panel 26, the covering film 22 is removed from the adhesive tape on the front passenger-seat leaf 16 which is rotated onto the front passenger-seat panel 23 pressed onto a rear portion of a corresponding one of the at least one front rigid roof panel, i.e., the front passenger-seat panel 23. The hinge is now as illustrated in FIG. 8. Finally, the driver-seat panel (not shown) is replaced on the vehicle in a closed position covering a front interior portion of the vehicle and the procedure is repeated for the front passenger-seat panel 23.

In an embodiment, the adhesive tape is a double sided commercial high strength tape. Use of adhesive tape makes installation easy and avoids drilling as many as 28 holes in the vehicle roof to attach the hinge, as in known designs. The tape may be an acrylic foam, which is naturally viscoelastic (both elastic and able to retain strength while being stretched to fit around any object) and resistant to ultraviolet light, temperature, water and other chemicals. An example is VHB tape, sold by several companies, including 3M′s fhb 5952, Applied AFTC 6411 which may be applied in combination with adhesion promoter 3M # 06396. Thickness of the tape may range from 0.045 inch to 0.250 inch. VHB tape has energy absorbing and stress relaxing properties, which allows it to conform and adhere to surfaces on both sides and move with the movable panel to which it is attached.

In an embodiment, the surface of the hinge to which the double-sided adhesive tape 22 is attached, is molded with a textured, milled surface, rather than being smooth, thereby allowing the adhesive to bond more tightly to the hinge. The opposite surface of the hinge, external after installation, may be smooth or textured.

The dimensions of the hinge can be adapted to fit the rear rigid roof panel 26 and removable panels 23 of the vehicle. The hinge 10 illustrated in FIGS. 1-8 has a large footprint to provide large areas covered by the double-sided adhesive tape 22, as illustrated in FIG. 3. Use of a continuous hinge pin 20 maintains proper alignment of the hinge when open, closed and during movement between those positions. The pin 20 can be made from stainless steel, aluminum, plastic or any other material with sufficient durability. The pin 20 may be press fit into the hinge so that at least during installation there is resistance to movement enabling the hinge to maintain any angle, including the 90° angle illustrated in FIGS. 6 and 8. The size of the barrel around pin 20 may be large enough to provide stiffness and strength when the panels 23 are open, while the pin 20 provides sufficient flexibility to allow the hinge to match the contour of the vehicle's roof.

After the hinge has been installed, the user can move the drivers side panel, separately from the passenger side panel 23, to an open position after being rotated at the rotatable connection and inverted on top of the rear rigid roof panel. In an embodiment, rubber bumpers (not shown) are attached to the front tip of ribs on the removable panels, so that when one or both panels are open, each rests on the rubber bumpers to keep the panels from getting damaged as well as acting as a vibration dampening device . The roofs nest together, upside down, in the open position, the same way they do when they are in the closed position. The at least one front rigid roof panel is held in place in the open position while the vehicle is moving forward by a combination of the hinge 10, gravity and airflow from in front of the vehicle, past the rotatable connection and over the at least one front rigid roof panel, prior to reaching an uncovered portion of the rear rigid roof panel 26. The user is able to quickly flip the roof panel(s) back into place and be latched down over the front seats.

A second embodiment of the hinge is illustrated in FIG. 9, prior to insertion of the rods 20. The sides of the leaves 12, 14, 16 closest to the left and right sides of the vehicle are angled toward the front of the vehicle, so that there is less material on the front leaves 14, 16 and more material on the rear leaf 12, than in the first embodiment illustrated in FIGS. 1-8. The second embodiment is designed to fit the roof of a Jeep® Wrangler Model JL which has removable roof panels that are curved at the outside rear corner, while providing roughly the same size surface area for bonding to the removable roof panels, as the first embodiment. Similar adjustments to the shape and/or size of the hinge may be made for removable roof panels of other vehicles. A hinge with a single front leaf could be used for a vehicle with a single removable roof panel, like a Targa® roof, although it is desirable to have a fixed, rear portion of the roof of sufficient size to support the movable roof panel when opened which may not be true of some previous such vehicle roofs. The hinge also could be adapted to fit T-top roofs, either by using two hinges or separating the front leaves 14, 16. If a vehicle is produced with more than two removable panels, the hinge(s) could be similarly adapted to fit.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A hinge attaching at least one front rigid roof panel to a rear rigid roof panel of a vehicle, comprising:
a single rear leaf configured to attach to a front portion of the rear rigid roof panel of the vehicle;
at least one front leaf, each configured to attach to a rear portion of a corresponding one of the at least one front rigid roof panel of the vehicle; and
at least one rotatable connection, each connecting one of the at least one front leaf to the single rear leaf.

2. The hinge according to claim 1,
wherein the at least one front rigid roof panel has a closed position covering a front interior portion of the vehicle and an open position after being rotated at the rotatable connection and inverted on top of the rear rigid roof panel, and
wherein the at least one front rigid roof panel is held in place in the open position while the vehicle is moving forward by a combination of the hinge, gravity and airflow from in front of the vehicle, past the rotatable connection and over the at least one front rigid roof panel, prior to reaching an uncovered portion of the rear rigid roof panel.

3. The hinge according to claim 2, wherein each of the at least one rotatable connection forms a continuous hinge.

4. The hinge according to claim 2, wherein the single rear leaf has a protruding lower front lip on the single rear leaf, thereby providing alignment with a leading edge of the rear rigid roof panel.

5. The hinge according to claim 4, wherein the protruding lower front lip is formed as a series of locating tabs.

6. The hinge according to claim 2, further comprising adhesive tape on bottom sides of the single rear leaf and the at least one front leaf, attaching the single rear leaf and the at least one front leaf to the rear rigid roof panel and the at least one front rigid roof panel, respectively, when the hinge is installed on the vehicle.

7. The hinge according to claim 6, wherein the adhesive tape covers over 95% of the bottom side of the single rear leaf and the at least one front leaf.

8. A motor vehicle, comprising:
a body; and
a roof supported by the body, having
at least one front rigid roof panel;
a rear rigid roof panel; and
a hinge, having
a single rear leaf configured to attach to a front portion of the rear rigid roof panel of the vehicle;
at least one front leaf, each configured to attach to a rear portion of a corresponding one of the at least one front rigid roof panel of the vehicle; and
at least one rotatable connection, each connecting one of the at least one front leaf to the single rear leaf.

9. The motor vehicle according to claim 6,
wherein the at least one front rigid roof panel has a closed position covering a front interior portion of the vehicle and an open position after being rotated at the rotatable connection and inverted on top of the rear rigid roof panel, and
wherein the at least one front rigid roof panel is held in place in the open position while the vehicle is moving forward by a combination of the hinge, gravity and airflow from in front of the vehicle, past the rotatable connection and over the at least one front rigid roof panel, prior to reaching an uncovered portion of the rear rigid roof panel.

10. The motor vehicle according to claim 6, wherein each of the at least one rotatable connection forms a continuous hinge.

11. The motor vehicle according to claim 6, wherein the single rear leaf has a protruding lower front lip on the single rear leaf, thereby providing alignment with a leading edge of the rear rigid roof panel.

12. The motor vehicle according to claim 11, wherein the protruding lower front lip is formed as a series of locating tabs.

13. The motor vehicle according to claim 6, further comprising adhesive tape on bottom sides of the single rear leaf and the at least one front leaf, attaching the single rear leaf and the at least one front leaf to the rear rigid roof panel and the at least one front rigid roof panel, respectively, when the hinge is installed on the vehicle.

14. The motor vehicle according to claim 13, wherein the adhesive tape covers over 95% of the bottom side of the single rear leaf and the at least one front leaf.

15. A method for attaching a bottom surface a hinge to a vehicle having a roof removable rigid front panels and a rigid rear panel permanently attached to the vehicle, comprising:
preparing the removable rigid front panels and the rigid rear panel for application of an adhesive;
removing a first front panel, corresponding to a first front leaf of the hinge, from the roof of the vehicle;
aligning the rigid rear panel with a rear leaf of the hinge and a second front panel, remaining on the vehicle, with a second front leaf of the hinge corresponding to the second front panel;
attaching the rear leaf to the rigid rear panel by the adhesive;
attaching the second front leaf to the second front panel by the adhesive;
replacing the first front panel onto the roof; and
attaching the first front leaf to the first front panel by the adhesive.

16. The method according to claim 15, wherein said preparing includes cleaning and applying an adhesion promotor to the removable rigid front panels and the rigid rear panel.

17. The method according to claim 15, wherein said aligning comprises:
aligning inner edges of the second front panel and the second front leaf of the hinge; and
pressing key tabs on a lower front edge of the rear leaf of the hinge into a gap between the rigid rear panel and the second front panel and against a leading edge of the rigid rear panel.

18. The method according to claim 17, wherein said attaching of the rear leaf to the rigid rear panel comprises:
removing a first film covering first adhesive tape on the bottom surface of the rear leaf, while maintaining alignment of the key tabs with the leading edge of the rigid rear panel and the inner edges of the second front panel and the second front leaf; and
pressing the rear leaf onto the rigid rear panel.

19. The method according to claim 18, wherein said attaching of the second front leaf to the second front panel comprises:
removing a second film covering second adhesive tape on the bottom surface of the second front leaf; and
pressing the second front leaf onto the second front panel.

20. The method according to claim 19, wherein said attaching of the first front leaf to the first front panel comprises:
removing a third film covering third adhesive tape on the bottom surface of the first front leaf; and
pressing the first front leaf onto the first front panel.
